(19) United States
(12) Patent Application Publication
(10) Pub. No.: US 2016/0203478 A1
(43) Pub. Date: Jul. 14, 2016

(54) SYSTEM AND METHOD FOR COMPARING ELECTRONIC TRANSACTION RECORDS FOR ENHANCED SECURITY

(71) Applicant: TACTILIS SDN BHD, Kuala Lumpur (MY)

(72) Inventors: Michael Gardiner, Kuala Lumpur (MY); Adriano Canzi, Los Angeles, CA (US)

(73) Assignee: TACTILIS SDN BHD, Kuala Lumpur (MY)

(21) Appl. No.: 14/596,472

(22) Filed: Jan. 14, 2015

(51) Int. Cl. G06Q 20/38; G06Q 20/32; G06Q 20/40; G06Q 20/34; G06Q 20/36; G06Q 20/20

(52) U.S. Cl. CPC G06Q 20/382; G06Q 20/3674; G06Q 20/20; G06Q 20/40145; G06Q 20/341; G06Q 20/322

(57) ABSTRACT

A system and method for enhancing security of a new transaction involving a portable transaction device by reconciling electronic transaction records is described. The method comprises receiving a first record of one or more previous electronic transactions involving the electronic portable transaction device from a first storage device; receiving a second record of one or more previous electronic transactions involving the electronic portable device from a second storage device; comparing the first record and the second record; and providing an indication of a match between the first record and the second record.

### CROSS-REFERENCE TO RELATED APPLICATIONS

The present application is related to concurrently filed U.S. patent application Ser. No. ______, entitled “System and Method for Requesting Reconciliation of Electronic Transaction Records for Enhanced Security”; U.S. patent application Ser. No. 14/596,420, entitled “System and Method for Reconciling Electronic Transaction Records for Enhanced Secutity”; and U.S. patent application Ser. No. ______, entitled “Smart Card Systems Comprising a Card and a Carrier,” which are all incorporated herein by reference in their entirety.

### FIELD OF THE INVENTION

The present invention relates to electronic transactions. More specifically, the present invention relates to systems and methods for reconciling electronic transaction records for enhanced security.

### BACKGROUND

Electronic transactions—such as for payments or access to a facility or computer—can be conducted using electronic portable transaction devices, such as smart cards or mobile devices. A smart card is a device that includes an embedded integrated circuit chip that can be either a secure processing module (e.g., microprocessor, microcontroller or equivalent intelligence) operating with an internal or external memory or a memory chip alone. Smart cards can provide identification, authentication, data storage, and application processing. Smart cards can serve as credit or ATM debit cards, phone or fuel cards, and high-security access-control cards for granting access to a computer or a physical facility. Smart cards can authenticate identity of the user by employing a token, such as public key infrastructure (PKI) and one-time-password (OTP). In addition, smart cards can be configured for a biometric authentication to provide an additional layer of security.

Similarly, mobile devices such as smartphones, PDAs, tablets, and laptops can provide a platform for electronic transactions. For example, a user of a mobile device can conduct an electronic transaction for purchase of a product or service using an application that communicates with a mobile payment service. Mobile devices can be configured for a token-based authentication and/or a biometric authentication.

These methods, however, are not immune to identity theft. For example, an identity thief can potential steal a token associated with a smart card or a mobile device and use the token to conduct a fraudulent transaction. What is needed is an additional layer of security that can eliminate or reduce risk for such a fraudulent transaction.

### BRIEF SUMMARY OF THE INVENTION

Various embodiments of the present disclosure are directed to enhancing security of electronic transactions through reconciliation of prior electronic transactions.

In accordance with the technology described herein, a method of enhancing security of a new electronic transaction involving an electronic portable transaction device comprises receiving a first record of one or more previous electronic transactions involving the electronic portable transaction device from a first storage device; receiving a second record of one or more previous electronic transactions involving the electronic portable device from a second storage device; comparing the first record and the second record; and providing an indication of a match between the first record and the second record.

In accordance with the technology described herein, a device for enhancing security of a new electronic transaction involving an electronic portable transaction device comprises a processor configured to execute a program configured to: receive from a first storage device a first record of one or more previous transactions involving the electronic portable transaction device, receive from a second storage device a second record of one or more previous transactions involving the electronic portable transaction device, compare the first record to the second record, and provide an indication of a match between the first record and the second record; and a memory configured to store the program.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF SEVERAL VIEWS OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram of an example electronic transaction system within which various embodiments of the technology disclosed herein may be implemented.

FIG. 2 is a block diagram of an example electronic transaction system implementing a reconciliation-based authentication procedure according to certain aspects of the present disclosure.

FIG. 3 is a block diagram of another example electronic transaction system implementing a reconciliation-based authentication procedure according to certain aspects of the present disclosure.

FIG. 4 is a block diagram of another example electronic transaction system implementing a reconciliation-based authentication procedure according to certain aspects of the present disclosure.

FIG. 5 is a block diagram of another example electronic transaction system implementing a reconciliation-based authentication procedure according to certain aspects of the present disclosure.

FIG. 6 is a block diagram of an example computer access control system implementing a reconciliation-based authentication procedure according to certain aspects of the present disclosure.

FIG. 7 is a block diagram of an example facility access control system implementing a reconciliation-based authentication procedure according to certain aspects of the present disclosure.

FIG. 8 is a flowchart illustrating an example reconciliation-based authentication procedure from the perspective of a device configured to perform the procedure according to certain aspects of the present disclosure.

FIG. 9 is a flowchart illustrating an example reconciliation-based authentication procedure from the perspective of a device configured to send a request the procedure according to certain aspects of the present disclosure.

### DETAILED DESCRIPTION

The present disclosure addresses this and other problems associated with electronic transactions by providing a procedure for authenticating an electronic portable transaction device based on reconciliation of previous transaction records (hereinafter “reconciliation-based authentication procedure”). A first record of one or more previous transactions involving the electronic portable transaction device is reconciled with a second record of one or more previous transactions involving the electronic portable transaction device.

In the following detailed description, numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

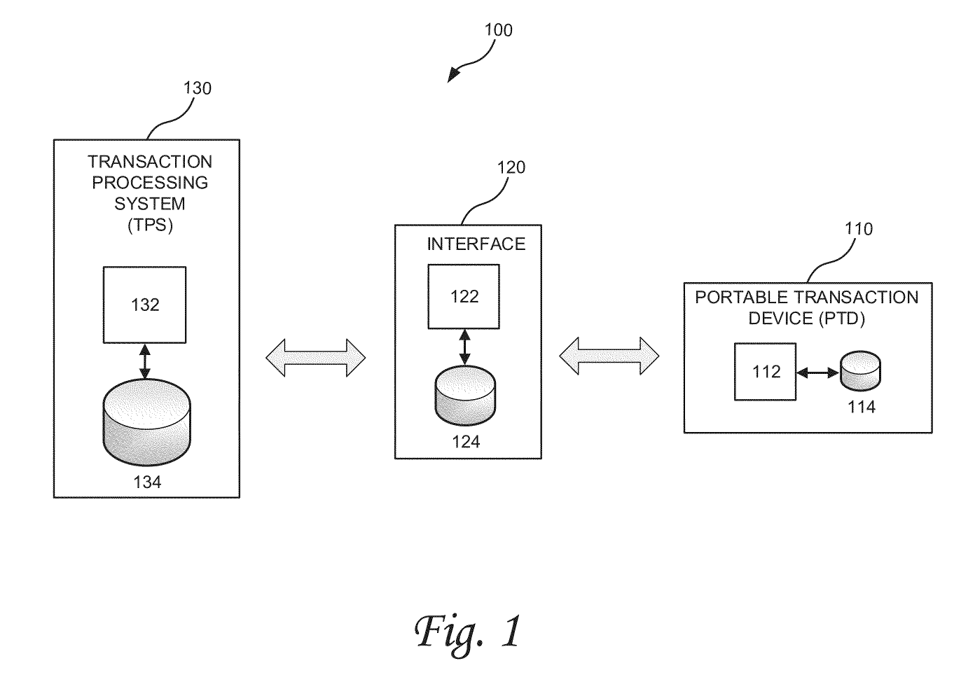

FIG. 1 is a block diagram of an example electronic transaction system 100 that can implement a reconciliation-based authentication procedure according to certain aspects of the present disclosure. The system 100 includes an electronic portable transaction device (PTD) 110, a transaction processing system (TPS) 130, and an interface device 120 that facilitates communications between the PTD 110 and the TPS 130. The PTD 110 can be, for example, a smart card, a smart key, a smart fob, or a mobile device. In some embodiments, the PTD 110 can include a biometric authentication module (not shown) for biometric authentication.

The PTD 110 can conduct various types of electronic transactions with the TPS 130 via the interface device 120. For financial transaction applications, the PTD 110 can be a smart payment card such as a smart credit, debit, and/or prepaid card, or a smartphone with a payment transaction application. The TPS 130 can be a payment processing system of a merchant (e.g., Target®), a bank (e.g., Bank of America®), or a card issuer (e.g., Visa®). The interface device 120 can be a point of sale (POS) terminal that can communicate with the PTD 110 using a contact method (e.g., matching male and female contact pads) or a contactless method (e.g., RFID, Bluetooth, NFC, Wi-Fi, ZigBee).

For access control applications, the PTD 110 can be a smart access card for providing access to a facility or computer. The TPS 130 can be a server in a central computer system, or a dedicated access controller that controls an access to a facility or computer. Interface device 120 can be a card reader that can communicate with the PTD 110 using a contact method (e.g., contact pads) or a contactless method (e.g., RFID, Bluetooth, NFC, Wi-Fi, ZigBee).

In the illustrated example of FIG. 1, the PTD 110 includes a processing module 112 and a data storage device 114; the interface device 120 includes a processing module 122 and a data storage device 124; and the TPS 130 includes a processing module 132 and a data storage device 134. In some embodiments, the PTD 110 can include a biometric authentication module (not shown) that includes a biometric sensor and a controller. The processing modules 112, 122, and 132, depending on the application, may be a microprocessor, microcontroller, application-specific integrated circuit (ASIC), field-programmable gate array (FPGA), computer, server, or any combination of components or devices configured to perform and/or control the functions of the PTD 110, interface device 120, and TPS 130, respectively. The data storage devices 114, 124, and 134, depending on the application, may be a read-only memory (ROM), such as EPROM or EEPROM, flash, a hard disk, a database, or any other storage component capable of storing executory programs and information for use by the processing modules 112, 122, and 132, respectively.

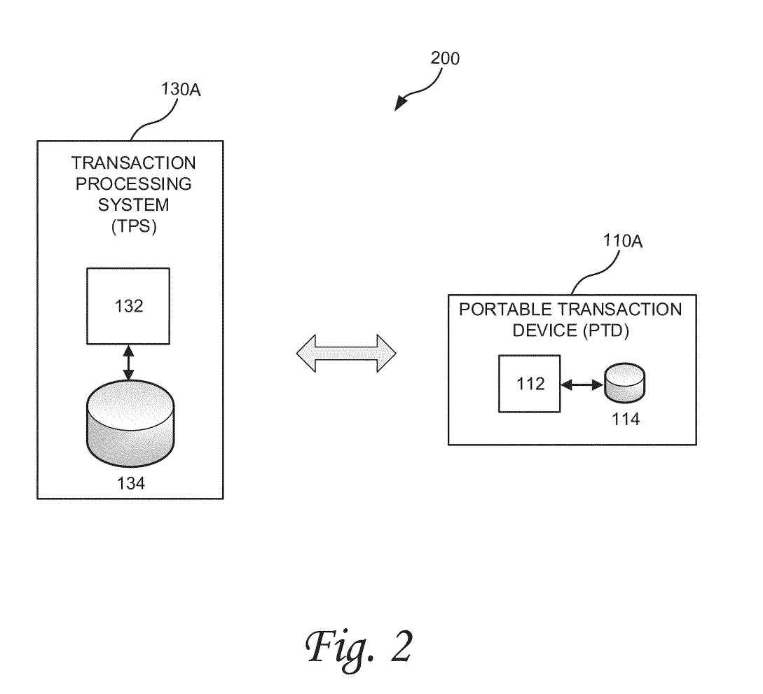

FIG. 2 is a block diagram of an example electronic transaction system 200 that implements a reconciliation-based authentication procedure according to certain aspects of the present disclosure As illustrated in FIG. 2, electronic transactions occur between a portable transaction device (PTD) 110A and a transaction processing system (TPS) 130A without an interface device. By way of example, a shopper may use a smartphone equipped with a camera to capture an image of a code (e.g., bar or QR code) to make a payment for a product or service by transmitting payment information to a card payment processing system via a cellular network. By way of another example, an access card reader at a facility may store information (e.g., passwords and/or security tokens) associated with employees authorized to enter the facility and, upon reading an access card, may compare security information received from the card with the stored information and grant or deny access depending on the outcome of the comparison.

In accordance with various aspects of the present disclosure, security of electronic transactions involving an electronic portable transaction device, such as a smart card or a mobile device, can be improved by providing a reconciliation-based authentication procedure before a new transaction involving the portable transaction device is authorized. With reference to FIG. 1, after completion of a financial or access control transaction involving the PTD 110, data items relating to the transaction may be stored in at least two of the data storage devices 112, 124, and 134 designated for storage of transaction records. In this manner, the designated storage devices can accumulate data items relating to previously completed transactions involving the PTD 110. By way of example, if the PTD 110 is a smart payment card used for purchase of products and the TPS 130 is a payment processing system, the memory 114 in the card 110 and the database 134 at the payment processing system 130 can store records of transaction-related data items, such as the tokens or passwords used, names and locations of the stores where the purchases were made, UPC codes of the products purchased, and/or times and amounts of the transactions. If the PTD 110 is a smart access card for a facility and TPS 130 is a central facility access controller, the memory 114 and the database 134 can store records of data items, such as the tokens and/or passwords used, the name of the facility (e.g., Warehouse #107), entry points (e.g., Southeast door #3), and/or times of the entries. If the PTD 110 is a smart access card for a computer or computer network, the memory 114 and the database 134 can store records of data items, such the tokens or passwords used, IDs of the computers or computer networks accessed, times and durations of the accesses, and/or the list of files and applications accessed.

In certain embodiments, the records of transaction-related data items stored in designated storage devices may be different. By way of example, in the smart payment card embodiment, the memory 114 at the PTD 110 may store security tokens, transaction times, and transaction amounts while the database 134 at the TPS 130 may store security tokens, store names and locations, and UPC codes of the products purchased. As long as there is at least one common data type stored in the designated storage devices (security token in this example), reconciliation of the transaction records can be performed.

In some embodiments, a reconciliation of a first record and a second record can include comparing a first set of one or more most-recent transactions in the first record stored in a first storage device with a second set of one or more most-recent transactions stored in a second storage device, and determining whether there is at least a predetermined number of matches between the two sets of most-recent transactions. In some embodiments, the first and second records are determined to be reconciled as long as there is at least one match between the two sets. In other embodiments, the first and second records are determined to be reconciled only if there are matches for all transactions in the two sets.

In some embodiments, a reconciliation of a first record and a second record can include comparing a first set of one or more previous transactions in the first record that satisfy certain predetermined criteria with a second set of one or more previous transactions in the second record that satisfy the same predetermined criteria, and determining whether there is at least a predetermined number of matches between the first set and the second set. In various embodiments, the predetermined criteria can include a minimum amount for a transaction. In this manner, the first and second sets being compared include only data items for which the amount of the transaction is greater than the minimum amount (e.g., $20). In various embodiments, the predetermined criteria can include transactions involving one or more entities (e.g., merchants, stores, banks, facilities, computer networks) that support the reconciliation-based authentication procedure.

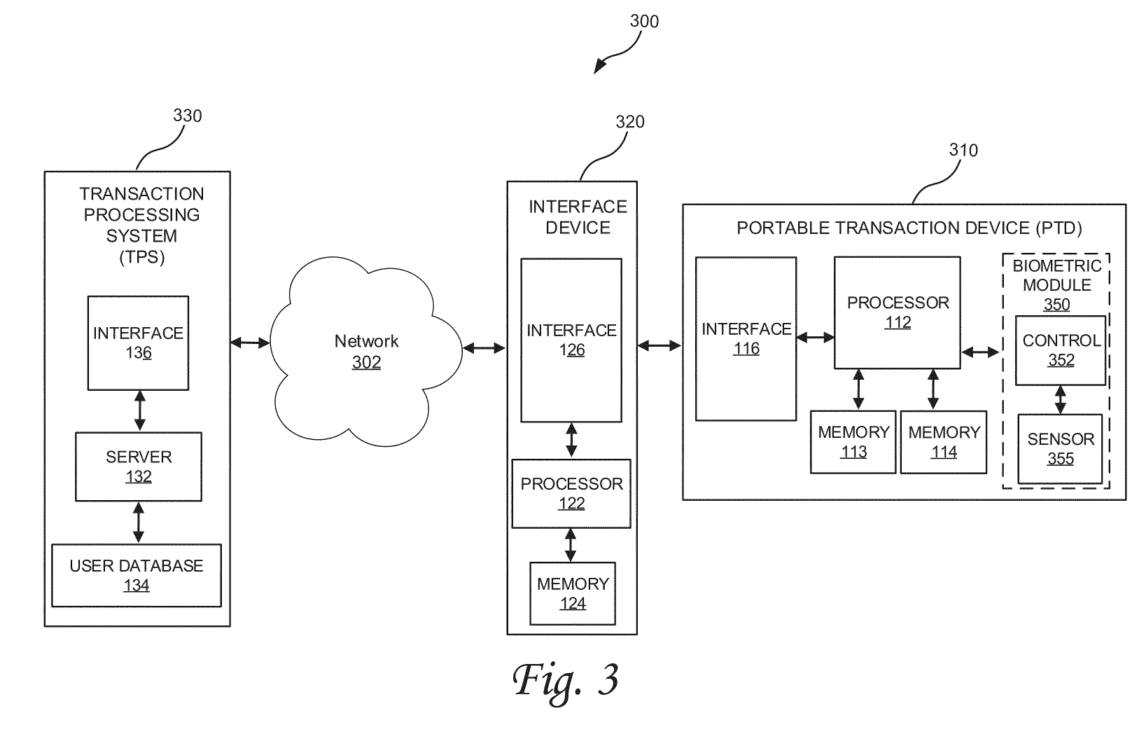

FIG. 3 is a block diagram of an example electronic transaction system 300 that can implement a reconciliation-based authentication procedure according to certain aspects of the present disclosure. In the illustrated example, the system 300 includes an electronic portable transaction device (PTD) 310, an interface device 320, and a transaction processing system (TPS) 330. In some embodiments, the PTD 310 is a smart card, in which case the interface device 320 can be a card reader. In some embodiments, the PTD 310 is a mobile device such as a smart phone, PDA, or tablet, in which case the interface device 320 can be an optical scanner or camera that can read a code presented on a display of the mobile device, or a Bluetooth, Wi-Fi or a near field communication (NFC) device that can communicate authentication-and/or transaction-related data between the mobile device and the TPS 330. In some embodiments, the PTD 310 is a smart card and the interface device 320 is a mobile device, in which case the smart card can perform authentication-related functions and the mobile device can provide a communication link between the smart card and the TPS 330.

In the illustrated embodiment of FIG. 3, the PTD 310 includes a processor 112, a first memory 113 and a second memory 114, and an interface 116. In certain embodiments, the first memory 113 can store a program that performs various communication and transaction functions of the PTD 310, and the second memory 114 can store a password, token, and/or other identification information unique to the PTD 310 and a record of previous transactions involving the PTD 310. In some embodiments, the first memory 113 and/or the second memory 114 can be part of the processor 112. In various embodiments, the first memory 113 and the second memory 114 may be a single memory component. The interface device 320 includes a processor 122, a memory 124, and an interface 126. The TPS 330 includes one or more processing modules including a server 132, one or more data storage devices including a user database 134, and an interface 136 for communicating with the interface device 320 via a communication network 302. In some embodiments, the user database 134 can store various data items relating to the PTD 310, including a password and data items relating to previously completed transactions involving the PTD 310.

The interface 116 and the interface 126 provide a communication link between the PTD 310 and the interface device 320. Using this communication link, the PTD 110 can communicate authentication-and/or transaction-related data with the interface device 120 and/or the TPS 130. In some embodiments, the PTD 110 can also receive power in the form of a voltage and/or current from the interface device 120 via the interfaces 116, 126. In certain embodiments, the interfaces 116, 126 can include a pair of male and female contact pads provided in the PTD (e.g., a smart card) and the interface device (e.g., a POS terminal). In some embodiments, the interfaces 116, 126 can include a pair of transceivers supporting wireless standards such as RFID, Bluetooth, Wi-Fi, NFT, and ZigBee. In some embodiments, the interface 116 can be a display of the mobile terminal that presents a code (e.g., a bar code or QR code) and the interface 126 can be an optical/infrared code scanner coupled to a POS terminal. In some embodiments, the interfaces 116,126 are a pair of wireless transceivers in a mobile device (e.g., a smartphone) and a POS terminal, respectively. In some embodiments, where the PTD 110 is a contactless smart card and the interface device 120 is a mobile device (e.g., a smartphone), the interfaces 116, 126 can include a pair of wireless transceivers in the contactless smart card and the mobile device, respectively.

In some embodiments, the PTD 110 is a mobile device that communicates with the TPS 130 via a wide area wireless network, such as a 3G UMTS or 4G LTE network, without the need for an interface device 120. In some embodiments, the PTD 110 is a smart card having a wireless capability that allows the card to communicate with the TPS 130 via a cellular network, such as a 3G UMTS or 4G LTE network, without the need for an interface device 120.

In certain embodiments, the processor 112 is configured to perform an authentication procedure using a security token stored in the first memory 113. Such a token-based authentication procedure is known in the art, and an exemplary procedure is described in “EMV® Payment Tokenisation Specification, Technical Framework” version 1.0, March 2014, which is incorporated herein by reference for all purposes.

In certain embodiments, the PTD 110 can include a biometric authentication module 350 that includes a control 352 and a biometric sensor 355. In other embodiments, the biometric authentication module 350 can be in the interface device (e.g., a POS terminal) instead of in the PTD 110. Biometric authentication can begin with the collection of a digital biometric sample (e.g., bitmap image of user's fingerprint) using the biometric sensor 355. Useful features contained in the collected sample are then extracted and formatted into a template record that can be matched against other template records. In various embodiments, the template is stored at registration (and when combined with identity vetting, establishes an identity) in a memory (not shown) inside the biometric authentication module 350 or in one of the first and second memories 113, 114. When a transaction takes place, the biometric sensor 355 can measure the same biometric characteristic and the control 352 can process the measured biometric characteristic into a template format, and compare the template to the previously registered template.

Biometric measurements may vary slightly from one measurement to the next. This variation is not typically due to changes in the biometric feature being measured but to the mechanism and environment in which the data are captured. Therefore, a biometric sample measured at registration may not precisely match the results of the live sample measurement. As a result of this variability, in various embodiments a similarity score is generated and this score is compared against a pre-determined threshold value to determine what constitutes an acceptable match.

As described above, various electronic transaction systems 100, 200, 300 of the present disclosure employ a reconciliation-based authentication procedure in addition to or in lieu of a token-based authentication procedure and a biometric authentication procedure. In embodiments that employ token-based and/or biometric-based authentication, a reconciliation-based authentication can be performed before, during, or after a token-based and/or biometric-based authentication to provide an extra layer of security.

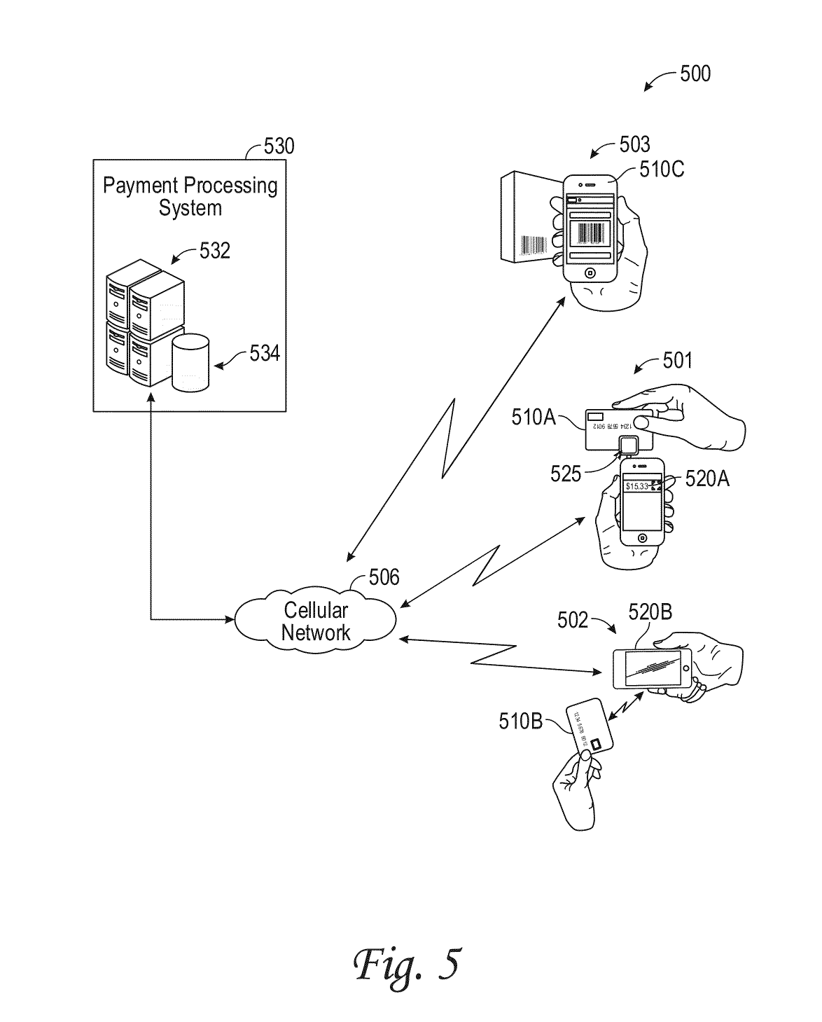

With a reference to the embodiment of FIG. 3, in a reconciliation-based authentication procedure, one or more data items related to a transaction involving the PTD 310, such as for payment or access to a facility or computer, can be stored in the second memory 114 at the PTD 310 after completion of each transaction. In addition, one or more data items related to the same transaction are stored in a data storage device located outside the PTD 110 such as the user database 134 at the TPS 330 and/or the memory 124 at the interface device 320. When a user initiates a new transaction using the PTD 110, a first transaction record of one or more previous transactions stored in the second memory 114 at the PTD 110 and a second record of one or more previous transactions stored in a data storage outside the PTD 110 (e.g., the database 134 or the memory 124) are retrieved and compared. In some embodiments, the comparison of the first and second records is performed by the processing module 132 at the TPS 330. In other embodiments, the comparison is performed by the processing module 122 at the interface device 120. In some embodiments, the comparison is performed by the processing module 112 at the PTD 310. In some embodiments, the comparison can be performed by more than one device. For example, in an embodiment where the PTD 310 is a smart card (e.g., a smart payment card), the TPS 330 is a payment processing system, and the interface device 120 is a mobile terminal (e.g., a smartphone) that communicates with the smart card (using e.g., RFID, Bluetooth, NFC, Wi-Fi, or ZigBee) and the TPS 330 (using, e.g., a cellular network), the smart card can perform one comparison and the mobile terminal can perform another comparison as described further below with respect to FIG. 5.

In some embodiments, a reconciliation-based authentication procedure can be initiated by a device that is different from a device that performs the reconciliation (e.g., comparison of the first and second records). For example, the TPS 330 can send a request for a reconciliation-based authentication in connection with a new transaction involving the PTD 310. In some embodiments, the TPS 330 can also send a first record of one or more previous transactions involving the PTD 310 that are stored in the database 134. The processor 122 at the interface device 320 can receive the request and the first record from the TPS 330, retrieve a second record of one or more previous transactions involving the PTD 310 from the memory 114, and compare the first record and the second record for a match. In other embodiments, the interface device 320 passes the request and the first record received from the TPS 330 to the PTD 310, and the processor 112 at the PTD 310 receives the request and the first record from the interface device 320, retrieve a second record of one or more previous transactions stored in the second memory 114 and compare the first record to the second record for a match. In some embodiments where the PTD 310 (e.g., a smartphone) has the capability to communicate with a cellular network, such as a 3G UMTS or 4G LTE network, the PTD 310 can receive the request and the first record from the TPS 330 via the cellular network without involving an interface device such as a POS terminal.

In some embodiments, the PTD 310 can send a request for a reconciliation-based authentication in connection with a new transaction involving the PTD 310. The PTD 310 can also send a first record of one or more previous transactions involving the PTD 310 that are stored in the second memory 114. The processor 122 at the interface device 320 can receive the request and the first record from the PTD 310, retrieves a second record of one or more previous transactions involving the PTD 310 from the database 134 at the TPS 330, and compares the first record and the second record for a match. In other embodiments, the interface device 320 passes the request for authentication and the first record received from the PTD 310 to the TPS 330, and the processor (e.g., server) 132 at the TPS 330 receives the request and the first record from the interface device 320, retrieves a second record of one or more previous transactions involving the PTD 310 stored in the database 134 and compares the first record to the second record for a match. In some embodiments where the PTD 310 (e.g., a smartphone) has the capability to communicate with a cellular network, such as a 3G UMTS or 4G LTE network, the PTD 310 can send the request and the first record to the TPS 330 via the cellular network without involving an interface device such as a POS terminal.

In some embodiments, the interface device 320 can initiate a reconciliation-based authentication procedure by sending a request for the authentication to either the PTD 310 or the TPS 330. If the request is sent to the PTD 310, the processing module 122 at the interface device 320 can retrieve a first record of one or more previous electronic transactions involving the PTD 310 from the user database 134 at the TPS 330 and send the first record to the PTD 310. The processing module 112 at the PTD 310 can receive the request and the first record from the interface device 320, retrieve a second record of one or more previous transactions stored in the memory 114, and perform a comparison between the first and second records for a match. On the other hand, if the request is sent to the TPS 330, the processing module 122 at the interface device 320 can retrieve a first record of one or more previous electronic transactions involving the PTD 310 from the second memory 114 at the PTD 310 and send the first record to the TPS 330. The server 132 at the TPS 330 can receive the request and the first record from the interface device 320, retrieve a second record of one or more previous transactions involving the PTD 310 stored in the database 134, and perform a comparison between the first and second records for a match.

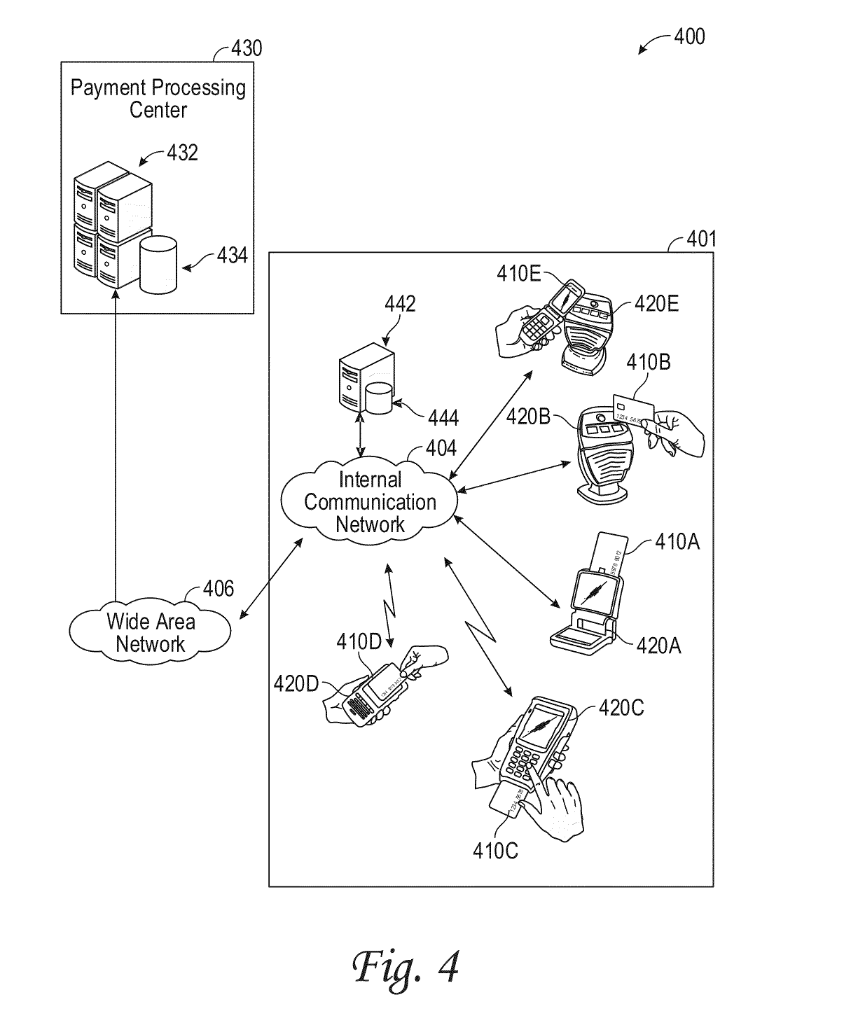

Various example arrangements of electronic transaction systems implementing a reconciliation-based authentication procedure are described below with respect to FIGS. 4-7. FIG. 4 depicts an example electronic payment transaction system 400 that implements a reconciliation-based authentication procedure according to certain aspects of the present disclosure. The system 400 includes a payment processing system 430 that includes one or more servers 432 and a user database 434 coupled to the servers 432. In some embodiments, the user database 434 can store various data items relating to card holders, including passwords and records of previously completed payment transactions. In various embodiments, the system 400 may include an internal or proprietary payment transaction system 401 of a merchant (e.g., Target®). Payment transaction system 401 may include various types of interface devices 420A-E that facilitate transaction-related communications between various types of portable payment transaction devices 410A-E and the server(s) 432 at the payment processing system 430. In the illustrated example, the portable payment transaction devices 410A-E are smart payment cards that can communicate with the interface devices 420A-E. Each of the portable payment transaction devices 410A-E can include all or some of the components 112, 113, 114, 116, 350, 352, and 355 of the PTD 310 depicted in FIG. 3. Each of the interface devices 420A-E can include all or some of the components 122, 124, and 126 of the interface device 320 depicted in FIG. 3. In the illustrated embodiment, the merchant's internal payment transaction system 401 further includes a server 442 and a database 444 that can store data items relating to the merchant's customers including passwords, tokens, and transaction records.

To enable communication between the payment processing system 430 and the merchant's internal payment transaction system 401, the interface devices 420A-E and the server 442 in the internal payment transaction system 401 have wired or wireless connections to an internal communication network 404 (e.g., Intranet), which is in turn connected a wide area network 406 (e.g., Internet). In this manner, the POS terminals 420A-E, the smart payment cards 410A-E, and the server 442 can engage in data communication with the server(s) 432 at the payment processing system 430.

In the illustrated example of FIG. 4, the interface device 420A is a fixed point of sale (POS) terminal that is configured to operate with a contact smart payment card 410A and has a wired connection (e.g., wired Ethernet) to the internal communication network 404. During a payment transaction, the contact smart payment card 410A is inserted into the POS terminal 420A for data communication. For this purpose, the contact smart payment card 410A can be equipped with male contact pads and the POS terminal 420A can be equipped with corresponding female contact pads or vice versa. Other methods of providing contact-based communication coupling between the contact smart payment card 410A and the POS terminal 420A, including micro connectors, can be utilized.

The interface device 420B is a fixed POS terminal that is configured to operate with a contactless smart payment card 410B and has a wired connection (e.g., wired Ethernet) to the internal communication network 404. During a payment transaction, the contactless smart payment card 410B is placed adjacent to the POS terminal 420B for wireless data communication. For this purpose, the contactless smart payment card 410B and the POS terminal 420B can be equipped with transceivers based on a wireless standard or technology, such as RFID, Bluetooth, NFC, Wi-Fi, and ZigBee.

The interface device 420C is a portable POS terminal that is configured to operate with a contact smart payment card 410C, and the portable POS terminal 420C has a wireless connection (e.g., wireless Ethernet) to the internal communication network 404. During a payment transaction, the contact smart payment card 410C is inserted into the portable POS terminal 420C for data communication. In various embodiments, the contact smart payment card 410C can be equipped with male contact pads and the POS terminal 420C can be equipped with corresponding female contact pads or vice versa. Other methods of providing contact-based communication coupling between the contact smart payment card 410C and the POS terminal 420C including, micro connectors, can be utilized.

The interface device 420D is a portable POS terminal that is configured to operate with a contactless smart payment card 410D, and POS terminal 420D has a wireless connection (e.g., wireless Ethernet) to the internal communication network 404. During a payment transaction, the contactless smart payment card 410D is placed adjacent to the portable POS terminal 420D for wireless data communication. For this purpose, the contactless smart payment card 410D and the POS terminal 420D can be equipped with transceivers based on a wireless standard or technology, such as RFID, Bluetooth, NFC, Wi-Fi, and ZigBee.

The interface device 420E is a fixed POS terminal that is configured to operate with a mobile device (e.g., a smartphone, PDA, tablet), and has either a wired connection (e.g., wired Ethernet) or a wireless connection (e.g., Wi-Fi) to the internal communication network 404. During a payment transaction, the mobile terminal 410E is placed adjacent to the POS terminal 420E for wireless data communication. For this purpose, the mobile terminal 410E and the POS terminal 420E can be equipped with transceivers based on a wireless standard or technology such as RFID, Bluetooth, NFC, Wi-Fi, and ZigBee. In certain alternative embodiments, the POS terminal 420E can have a wireless connection (e.g., wireless Ethernet) to the internal communication network 404. In some embodiments, the POS terminal 420E can be equipped with an optical scanner or camera that can read a code (e.g., bar code or QR code) displayed on a display of the mobile terminal 410E.

For ease of illustration only, without any intent to limit the scope of the present disclosure in any way, various aspects of operation of the electronic payment transaction system 400 will be described with respect to the contact smart payment card 410A and the POS terminal 420A. It shall be appreciated by those skilled in the art in view of the present disclosure that the described operation is applicable to other portable transaction devices (e.g., 410B-E) and interface devices (e.g., 420B-E).

In operation, a new transaction is initiated when a user presents the smart payment card 410A at the POS terminal 420A to pay for products and/or services by, for example, inserting the card 410A into the POS terminal 421 as shown in FIG. 4. Before authorizing the new transaction, one or more authentication procedures are performed to determine the authenticity of the smart payment card 410A and/or the identity of the user. For example, the card 410A in coordination with the POS terminal 420A and/or the payment processing system 432 can perform a token-based authentication procedure described above. Optionally, the card 410A, either by itself or in coordination with the POS terminal 420A and/or the payment processing system 432, can perform a biometric authentication procedure in addition to the token-based authentication procedure. To further enhance security of the transaction, the card 410A in coordination with the POS terminal 420A and/or the payment processing system 432 performs a reconciliation-based authentication procedure before, during, or after a token-based authentication and/or a biometric-based authentication.

In certain embodiments, the reconciliation-based authentication is performed at the payment processing system 430. By way of example, after making a data connection with the card 410A, the POS terminal 420A can retrieve (e.g., request and receive) a security token from the card 410A. The POS terminal 420A can also retrieve a first record of one or more previous transactions involving the card 410A from the memory 114. The POS terminal 420A can send a request for approval of the new transaction to the payment processing system 430 along with the security token and the first record retrieved from the card 410A. The server(s) 432 at the payment processing system 420 receives the request and the first record and performs an authentication with respect to the security token received from the POS terminal 420. Upon a successful token-based authentication, the server(s) 432 can perform a reconciliation-based authentication by determining whether the first record received from the POS terminal 420A can be reconciled with a second record of one or more previous transactions involving the card 410A stored in the user database 434.

In certain embodiments, the reconciliation-based authentication is performed at the POS terminal 420A. By way of example, after making a data connection with the card 410A, the POS terminal 420A can retrieve a security token and a first record of one or more previous transactions from the card 410A. The POS terminal 420A can send the security token to the payment processing system 430, and the server(s) 432 at the payment processing system 420 performs a token-based authentication. If the token-based authentication is successful, the server(s) 432 can retrieve a second record of one or more previous transactions involving the card 410A from the user database 434 and send the second record to the POS terminal 420A with an indication that the token-based authentication was successful. The processor 122 at the POS terminal 420A, upon receiving the second record, performs a reconciliation-based authentication by determining whether the first record received from the card 410A can be reconciled with the second record received from the payment processing system 430. In some embodiments, the POS terminal 420A can retrieve the second record from the database 444 in the merchant's internal payment transaction system 401 rather than from the database 434 at the payment processing system 430.

In certain embodiments, the reconciliation-based authentication is performed at the smart payment card 410A. By way of example, after making a data connection with the card 410A, the POS terminal 420A can retrieve a security token from the card 410A and send the security token to the payment processing system 430. The server(s) 432 at the payment processing system 420 performs a token-based authentication. If the token-based authentication is successful, the server(s) 432 retrieves a first record of one or more previous transactions involving the card 410A from the user database 434 and send the second record to the POS terminal 420A with an indication that the token-based authentication was successful. The POS terminal 420A, upon receiving the second record from the payment processing system, sends the second record to the card 410A. The processor 112 at the card 410A performs a reconciliation-based authentication by determining whether the first record received from the payment processing system 430 via the POS terminal 420A can be reconciled with a second record of one or more previous transactions stored in the memory 114 at the card 410A.

There can be many different ways of determining whether the first record and the second record are reconcilable. In certain embodiments, the reconcilability determination can involve comparing one or more transaction-related data items in the first record with one or more transaction-related data items in the second record and determining whether there is at least a predetermined number of matches. For example, security tokens and transaction times for the five (5) most-recent transactions in the first record can be compared to security tokens and transaction times for 5 most-recent transactions in the second record. If the comparison produces a number of matches that is equal to or greater than a predetermined number (e.g., 1-5 transactions matched), the first and second records are determined to be reconcilable and the new transaction is approved. On other hand, if the number of matches is less than the predetermined number, the first and second records are determined to be irreconcilable and the new transaction is denied.

In some embodiments, the reconcilability determination can involve comparing one or more previous transactions in the first record that satisfy certain criteria to one or more previous transactions in the second record that satisfy the same criteria. For example, one or more previous transactions in the first record that exceeded a predetermined transaction amount (e.g., $20) can be compared to one or more previous transactions in the second record that exceeded the same predetermined transaction amount. In this manner, small-amount transactions that do not require a reconciliation-based authentication are automatically excluded. By way of another example, one or more previous transactions in the first record that involved one or more specific entities (e.g., merchants, banks, or government agencies) can be compared to one or more previous transactions in the second record that involved the same entity or entities. For example, there can be a group of merchants that support or participate in a particular reconciliation-based authentication standard, although the smart payment card 410A can be used for transactions with other merchants that do not support the standard. In this example, only previous transactions from the first and second records that involved participating merchants are compared.

FIG. 5 depicts another example electronic payment transaction system 500 that implements a reconciliation-based authentication procedure according to certain aspects of the present disclosure. The system 500 includes a payment processing system 530 that includes one or more servers 532 and a user database 534 coupled to the server(s) 532. The sever(s) 532 conduct different types of electronic payment transactions 501, 502, 503 with mobile terminals 520A-C via a cellular network 506.

The first electronic payment transaction 501 involves a contact smart payment card 510A coupled to the mobile terminal 520A via a smart card reader 525 and conducting a payment transaction with the payment processing system 530 via the cellular network 506. The second electronic payment transaction 502 involves a contactless smart payment card 510B wirelessly coupled to the mobile terminal 520B and conducting a payment transaction with the payment processing system 530 via the cellular network 506. The third electronic payment transaction 503 involves the mobile terminal 510C as a portable transaction device and an interface device. In some embodiments, mobile terminal 510 can capture an image of a code (e.g., a bar or QR code) associated with a product printed on a package of the product, in a catalog, or advertisement using an image capture device (e.g., a camera) and conducting a payment transaction for the product with the payment processing system 530 via the cellular network 506.

In each of these payment transactions 501, 502, 503, a reconciliation-based authentication procedure similar to the reconciliation-based authentication procedures described above with respect to FIGS. 1-4 can be performed in addition to a token-based authentication and/or a biometric-based authentication for enhanced security. In the first payment transaction 501, reconciliation of a first record of one or more previous transactions involving the smart payment card 510A and a second record of one or more previous transactions involving the smart payment card 510A can be performed by the server(s) 532 at the payment processing system 530, a processor in the mobile terminal 520A, or a processor in the smart payment card 510A. The first record can be stored in a memory in the smart payment card 510A or in a memory in the mobile terminal 520A. The second record can be stored in the database 534 at the payment processing system 530 or in a memory in the mobile terminal 520A.

For the second payment transaction 502, reconciliation of a first record of one or more previous transactions involving the smart payment card 510B and a second record of one or more previous transactions involving the smart payment card 510B can be performed by server(s) 532 at the payment processing system 530, a processor in the mobile terminal 520B, or a processor in the smart payment card 510B. The first record can be stored in a memory in the smart payment card 510B or in a memory in the mobile terminal 520B. The second record can be stored in the database 534 at the payment processing system 530 or in a memory in the mobile terminal 520B.

For the third payment transaction 503, reconciliation of a first record of one or more previous transactions involving the mobile terminal 510C and a second record of one or more previous transactions involving the mobile terminal 510C can be performed by server(s) 532 at the payment processing system 530, or a processor in the mobile terminal 510C. The first record can be stored in a memory in the mobile terminal 510C, and the second record can be stored in the database 534.

In certain embodiments, multiple reconciliations (e.g. comparison of previous transactions for a match) can be performed by multiple devices. By way of example, in the first payment transaction 501, a processor in the smart payment card 510A can perform a first comparison of a first record of one or more previous transactions involving the card 510A retrieved from the database 534 at the payment transaction center 530 with a second record of one or more previous transactions involving the card 510A retrieved from a memory of the card 510A. In addition, a processor in the mobile terminal 520A can perform a second comparison of the first record of one or more previous transactions involving the card 510A retrieved from the database 534 at the payment transaction center 530 with a third record of one or more previous transactions retrieved from a memory of the mobile terminal 520A.

By way of another example of multiple reconciliations, the server 534 at the payment processing system 530 can perform a first comparison of a first record of one or more previous transactions involving the card 510A retrieved from the database 534 with a second record of one or more previous transactions involving the card 510A retrieved from a memory of the mobile terminal 520A. In addition, a processor in the smart payment card 510A can perform a second comparison of the first record of one or more previous transactions involving the card 510A retrieved from the database 534 at the payment transaction center 530 with a third record of one or more previous transactions retrieved from a memory of the card 510A. It shall be appreciated by those skilled in the art in view of the present disclosure that there are other configurations of devices and records for performing multiple reconciliations.

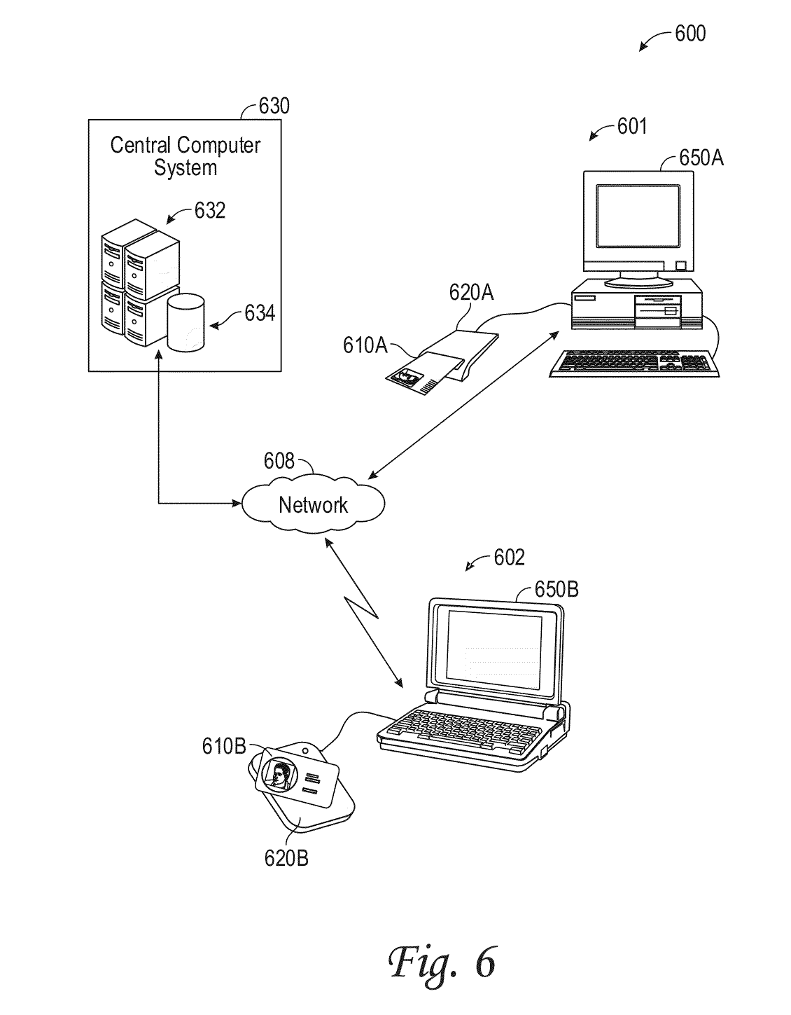

FIG. 6 depicts an exemplary computer access control system 600 that implements a reconciliation-based authentication procedure according to certain aspects of the present disclosure. FIG. 6 illustrates a first computer access transaction 601 involving a contact smart access card 610A and a card reader 620A, and a second computer access transaction 602 involving a contactless smart access card 610B and a card reader 620B. In the illustrated example, the system 600 further includes a central computer system 630 that includes one or more servers 632 and a database 634 coupled to the server(s) 632. The sever(s) 632 is connected to the computers 650A, 620B via a network 608, which can be a local area network (LAN) or a wide area network (WAN). In certain embodiments, the system 600 can allow a first group of users to access files and applications stored in and running on the computers 650A, 650B and allow a second group of users to access files and applications stored in and running on the computers 650A, 650B and the server(s) 632 and the database 634 in the central computer system 630.

In the first computer access transaction 601, a user can insert a contact smart access card 610A into a card reader 620A coupled to the desktop computer 650A for access to the desktop computer 650A and/or the central computer system 632. In the illustrated example, the desktop computer 650A is coupled to the network 608 via a wired connection. In the second computer access transaction 602, a user can place a contactless smart access card 610B adjacent to a card reader 620B coupled to a laptop computer 650B for access to the laptop computer 650B and/or the server(s) 632 and the database 634 in the central computer system 630. The laptop computer 650B is coupled to the network 608 via a wireless connection.

In each of these computer access transactions 601, 602, a reconciliation-based authentication procedure similar to the reconciliation-based authentication procedures described above with respect to FIGS. 1-4 can be performed in addition to a token-based authentication and/or a biometric-based authentication for enhanced security. For the first computer access transaction 601, a reconciliation (e.g., comparison) of a first record of one or more previous transactions involving the smart access card 610A and a second record of one or more previous transactions involving the smart access card 610A can be performed by server(s) 632 at the central computer system 630, a processor in the card reader 620A, a processor in the smart access card 610A, or a processor in the desktop computer 650A. The first record can be stored in a memory in the smart access card 610A, and the second record can be stored in the database 634 or in a memory in the desktop computer 650A. For the second computer access transaction 602, a reconciliation (e.g., comparison) of a first record of one or more previous transactions involving the smart access card 610B and a second record of one or more previous transactions involving the smart access card 610B can be performed by server(s) 632 at the central computer system 630, a processor in the card reader 620B, a processor in the smart access card 610B, or a processor in the laptop computer 650B. The first record can be stored in a memory in the smart access card 610B, and the second record can be stored in the database 634 or in a memory in the laptop computer 650B. In certain embodiments, a dedicated computer access controller (not shown) can be employed to control access to the computers 650A, 650B and/or the central computer system 630, a processing module (e.g., a processor) in the controller can perform one or more of a token-based authentication, a biometric-based authentication, and a reconciliation-based authentication, and a data storage device (e.g., a memory) in the controller can store records of computer access transactions for different users.

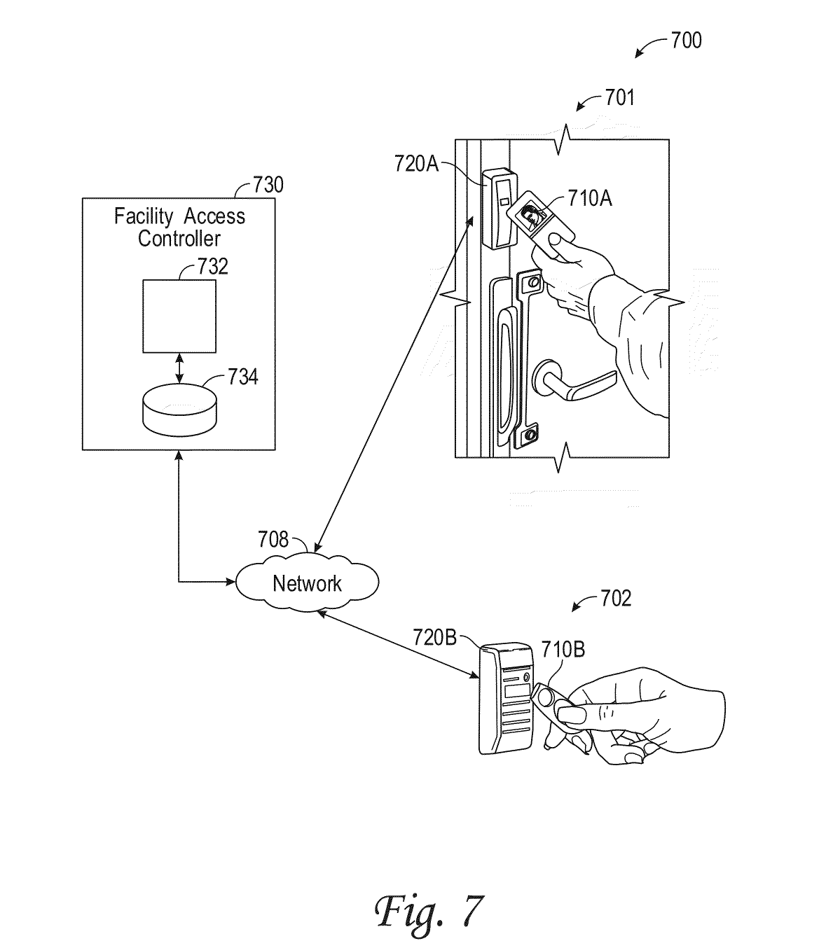

FIG. 7 depicts an exemplary facility access control system 700 that implements a reconciliation-based authentication procedure according to certain aspects of the present disclosure. FIG. 7 illustrates a first facility access transaction 710 involving a smart access card 710A and a card reader 720A, and a second facility access transaction 720 involving a smart access fob 710B and a fob reader 720B. In the illustrated example, the system 700 further includes a central facility access controller 730 that includes a processing module 732 and a data storage 734 coupled to the processing module 732. The processing module 732 is communicatively connected to the card reader 720A and the fob reader 620B via a communication network 708, which can be a local area network (LAN) or a wide area network (WAN).

In the first facility access transaction 701, a user presents the smart access card 710A to the card reader 720B to gain access to a facility. The card reader 720B can communicate with the card 710A using one of various contact or contactless methods, including non-limiting examples described above. In the second facility access transaction 702, a user presents the smart access fob 710A to the fob reader 720B to gain access to the facility.

In each of these facility access transactions 701, 702, a reconciliation-based authentication procedure similar to the reconciliation-based authentication procedures described above with respect to FIGS. 1-4 can be performed in addition to a token-based authentication and/or a biometric-based authentication for enhanced security. For the first facility access transaction 701, a reconciliation (e.g., comparison) of a first record of one or more previous transactions involving the smart access card 710A and a second record of one or more previous transactions involving the same smart access card 710A can be performed by the processing module 732 at the central facility access controller 730, a processor in the card reader 720A, or a processor in the smart access card 710A. The first record can be stored in a memory in the smart access card 710A, and the second record can be stored in the database 734 or in a memory in the card reader 730A. For the second facility access transaction 702, a reconciliation (e.g., comparison) of a first record of one or more previous transactions involving the smart access fob 710B and a second record of one or more previous transactions involving the same smart access fob 710B can be performed by the processing module 732 at the central facility access controller 730, a processor in the fob reader 720B, or a processor in the smart access fob 710B. The first record can be stored in a memory in the smart access fob 710B, and the second record can be stored in the database 734 or in a memory in the fob reader 720B.

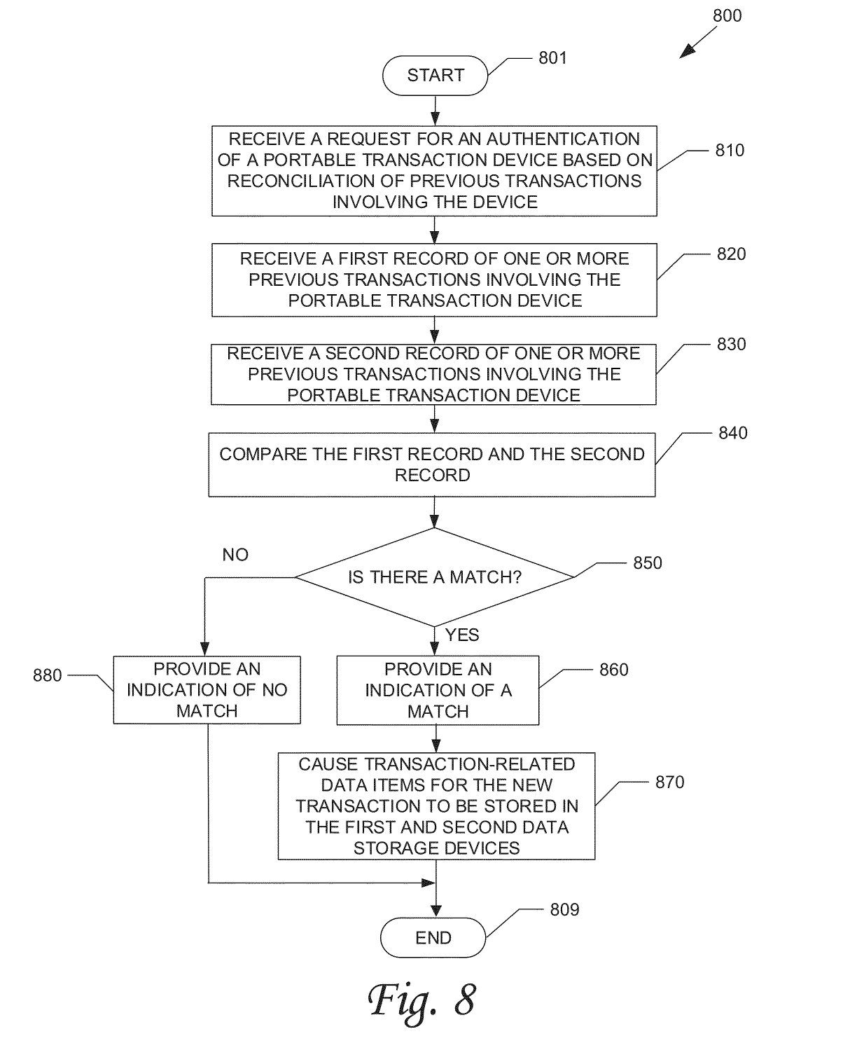

FIG. 8 is a flowchart illustrating an example process 800 for a reconciliation-based authentication procedure according to certain aspects of the present disclosure from the perspective of a device configured to perform the reconciliation-based authentication procedure.

The process 800 starts at state 801 and proceeds to operation 810, in which a processing module in a device receives a request for an authentication of the portable transaction device. The device that receives the request is hereinafter referred to as “the authentication device.” The authentication device can be the portable transaction device, a transaction processing system configured to process transactions involving the portable transaction device, or an interface device configured to facilitate communications between the portable transaction device and the transaction processing system. In some embodiments, the authentication device performs a token-based authentication and/or a biometric-based authentication before, during, or after the reconciliation-based authentication. Non-limiting examples of the portable transaction device include a smart payment card, a smart computer access card, a smart facility access card, a mobile terminal configured for payment transactions, or a mobile terminal configured for computer or facility access transactions. Non-limiting examples of the transaction processing system include a payment processing system (e.g., for credit card or debit card transactions), a central computer system (including, e.g., server(s) and database(s)), or a dedicated access controller. Non-limiting examples of the interface device include a fixed or portable POS terminal, a mobile terminal, and a contact or contactless smart card or smart fob readers.

The process 800 proceeds to operation 820, in which a processing module in the authentication device receives a first record of one or more previous transactions involving the portable transaction device from a first data storage device configured to store data items related to transactions involving the portable transaction device. Non-limiting examples of such transaction-related data items include tokens or passwords used, locations, transaction times and durations, products or services purchased, and/or accessed files and applications. The first data storage device can be a memory (e.g., a database) at the transaction processing system, a memory in the portable transaction device, or a memory in the interface device. The first data storage device can be in the authentication device or in another device in the electronic transaction system.

The process 800 proceeds to operation 830, in which a processing module in the authentication device receives a second record of one or more previous transactions involving the portable transaction device from a second data storage device configured to store data items related to transactions involving the portable transaction device. Non-limiting examples of such transaction-related data items include tokens or passwords used, locations, transaction times and durations, products or services purchased, and/or accessed files and applications. The second data storage device can be a memory (e.g., a database) at the transaction processing system, a memory in the portable transaction device, or a memory in the interface device. The second data storage device can be in the authentication device or in another device in the electronic transaction system.

The process 800 proceeds to operation 840, in which a processing module in the authentication device compares the first record to the second record to determine if there is a match. The comparison can involve one or more transaction-related data items in the first record with one or more transaction-related data items in the second record. For example, security tokens and transaction times in the first record can be compared to security tokens and transaction times in the second record.

The process 800 proceeds to query state 850, in which a processing module in the authentication device determines if there is a match between the first and second records. If the answer to the query is “yes” (i.e., there is a match), the process 800 proceeds to operation 860, in which the processing module provides an indication of the match to a device from which the authentication device received the request at operation 810. The process 800 proceeds to operation 870, in which a processor in the conciliation device causes one or more transaction-related data items for the new transaction be stored in the first storage device and the second storage device.

On the other hand, if the answer to the query at the state 850 is “no” (i.e., there is no match), the process 800 proceeds to operation 880, in which a processor in the authentication device provides an indication of no match to a device from which the authentication device received the request at operation 810. The process 800 ends a state 809.

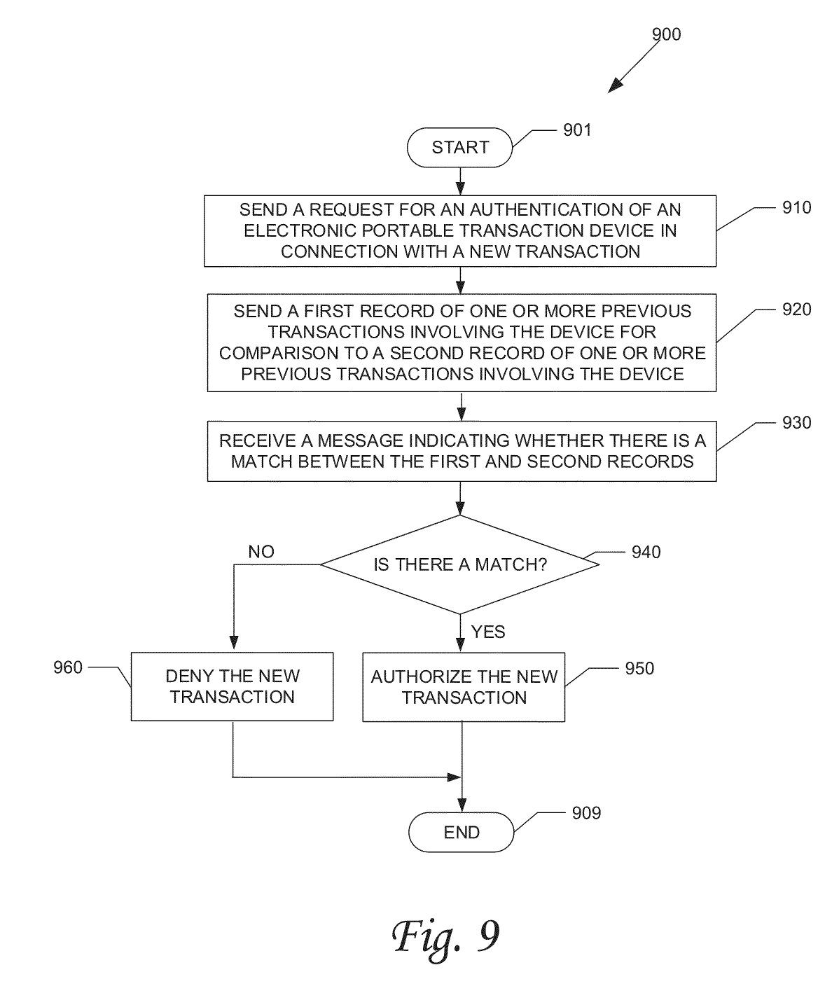

FIG. 9 is a flowchart illustrating an example process 900 for a reconciliation-based authentication procedure according to certain aspects of the present disclosure from the perspective of a device configured to send a request for an authentication. The process 900 starts at state 901 and proceeds to operation 910, in which a processing module in a device sends a request for an authentication of an electronic portable transaction device to the authentication device described above with respect to FIG. 8, either directly or via another device (e.g., an interface device). The device that sends the request is hereinafter referred to as “the requesting device.” The requesting device sends the authentication request in connection with a new transaction involving the electronic portable transaction device.

It shall be appreciated by those skilled in the art in view of the present disclosure that there are numerous possible pairs of a requesting device and an authentication device. In the electronic payment system 400 of FIG. 4, for example, the requesting device can be one of the interface devices 420A-E and the authentication device can be the corresponding one of the portable transaction devices 410A-E, or vice versa. Alternatively, the requesting device can be one of the portable transaction devices 410A-E and the authentication device can be server(s) 432 at the payment processing system 430, or vice versa. Alternatively, the requesting device can be the server(s) 432 at the payment processing system 430 and the authentication device can be one of the interface devices 420A-E, or vice versa. In the electronic payment system 500 of FIG. 5, the requesting device can be one of the mobile terminals 520A-B and the authentication device can be one of the smart payment cards 510A-B, or vice versa. Alternatively, the requesting device can be one of the mobile terminals 520A-C and the authentication device can be the server(s) 532 at the payment processing system 530, or vice versa. Alternatively, the requesting device can be the server(s) 532 at the payment processing system 530 and the authentication device can be one of the smart payment cards 510A-B, or vice versa.

The process 900 proceeds to operation 920, in which a processing module in the requesting device sends a first record of one or more previous transactions involving the electronic portable transaction device to the authentication device for reconciliation (e.g., comparison) with a second record of one or more previous transactions involving the electronic portable transaction device, either directly or via another device (e.g., an interface device).

The process 900 proceeds to operation 930 in which a processing module in the requesting device receives a message indicating whether there is a match between the first record and the second record.

The process 900 proceeds to query state 940, in which a processing module in the requesting device determines whether the message indicates that there is a match between the first record and the second record. If the answer to the query is “yes” (i.e., there is a match), the process 900 proceeds to operation 950, in which a processing module in the requesting device authorizes the new transaction for which the authentication request was sent in operation 910.

On other hand, if the answer to the query is “no” (i.e., there is no match), the process 900 proceeds to operation 960, in which a processing module in the requesting device denies the new transaction. In some embodiments, the requesting device may also cause the portable transaction device to be disabled. The process 900 ends at state 909.

It shall be appreciated by those skilled in the art in view of the present disclosure that various described operations of the exemplary processes 800 and 900 may be performed in different orders, optionally skipped, and/or removed. For example, in an electronic transaction system in which the authentication device is also the device that initiates and/or authorizes new transactions, the operation 810 in the process 800 illustrated in FIG. 8 and the process 900 illustrated in FIG. 9 may not be performed. In certain embodiments, the operation 870 relating to storage of transaction-related data items for the new transaction may not be performed by the authentication device as part of the process 800. Instead, such a storage is performed by the requesting device as part of the process 900 after receiving a message indicating a match between the first and second records.

The description of the technology is provided to enable any person skilled in the art to practice the various embodiments described herein. While the technology has been particularly described with reference to the various figures and embodiments, it should be understood that these are for illustration purposes only and should not be taken as limiting the scope of the various embodiments.

There may be many other ways to implement the various embodiments. Various functions and elements described herein may be partitioned differently from those shown without departing from the spirit and scope of the technology disclosed. Various modifications to these embodiments will be readily apparent to those skilled in the art, and generic principles defined herein may be applied to other embodiments. Thus, many changes and modifications may be made to the various embodiments, by one having ordinary skill in the art, without departing from the spirit and scope of the various embodiments.

A reference to an element in the singular is not intended to mean “one and only one” unless specifically stated, but rather “one or more.” The term “some” refers to one or more. Underlined and/or italicized headings and subheadings are used for convenience only, do not limit the scope of the various embodiments, and are not referred to in connection with the interpretation of the description of the embodiment. All structural and functional equivalents to the elements of the various embodiments of the technology described throughout this disclosure that are known or later come to be known to those of ordinary skill in the art are expressly incorporated herein by reference and intended to be encompassed by the technology disclosed. Moreover, nothing disclosed herein is intended to be dedicated to the public regardless of whether such disclosure is explicitly recited in the above description.

We claim:

1. A method of enhancing security of a new electronic transaction involving an electronic portable transaction device, the method comprising:
(a) receiving a first record of one or more previous electronic transactions involving the electronic portable transaction device from a first storage device;
(b) receiving a second record of one or more previous electronic transactions involving the electronic portable device from a second storage device;
(c) comparing the first record and the second record; and
(d) providing an indication of a match between the first record and the second record.

2. The method of claim 1, wherein the electronic portable transaction device is a smart card.

3. The method of claim 1, wherein the electronic portable transaction device is a mobile terminal.

4. The method of claim 1, wherein the new electronic transaction comprises a financial transaction.

5. The method of claim 1, wherein the new electronic transaction comprises an access control transaction.

6. The method of claim 1 further comprising: performing a token-based authentication; and performing the step (d) if the token-based authentication is also successful.

7. The method of claim 1 further comprising: performing a biometric authentication; and performing the steps (a)-(d) if the biometric authentication is successful.

8. The method of claim 1, wherein the steps (a)-(d) are performed at the electronic portable transaction device.

9. The method of claim 1, wherein the steps (a)-(d) are performed at a transaction processing system.

10. The method of claim 9, wherein the transaction processing system is a payment processing system.

11. The method of claim 1, wherein the steps (a)-(d) are performed at an interface device for facilitating communication between the electronic portable device and a transaction processing system.

12. The method of claim 11, wherein the transaction processing system is a payment processing system and the interface device is a point of sale terminal.

13. The method of claim 1, wherein the first storage device is located at the electronic portable transaction device, and the second storage device is located at a transaction processing system.

14. The method of claim 1, wherein the first storage device is located at the electronic portable transaction device, and the second storage device is located at an interface device for facilitating communication between the electronic portable device and a transaction processing system.

15. The method of claim 1, further comprising receiving a request for authentication of the electronic portable transaction device.

16. A device for enhancing security of a new electronic transaction involving an electronic portable transaction device, the device comprising:
a processor configured to execute a program configured to:
receive from a first storage device a first record of one or more previous transactions involving the electronic portable transaction device,
receive from a second storage device a second record of one or more previous transactions involving the electronic portable transaction device,
compare the first record to the second record, and
provide an indication of a match between the first record and the second record; and
a memory configured to store the program.

17. The device of claim 16, wherein the electronic portable transaction device is a smart card.

18. The device of claim 17, wherein the processor and the memory are part of the smart card.

19. The device of claim 17, wherein the smart card further comprises a set of contact pads configured to engage with a set of contact pads at a point of sale terminal.

20. The device of claim 16, wherein the electronic portable transaction device further comprises a transceiver configured to engage in wireless data communication with a point of sale terminal.

21. The device of claim 16, wherein the electronic portable transaction device portable further comprises a biometric authentication module.

22. The device of claim 21, wherein the processor is configured to provide the indication after receiving a notification indicative of a successful authentication from the biometric authentication module.
